(19) United States
(12) Patent Application Publication
(10) Pub. No.: US 2005/0182726 A1
(43) Pub. Date: Aug. 18, 2005

(54) Network virtual computing devices and framework

(75) Inventors: Glen Honeycutt, Huntsville, AL (US); Charles H. Williams, Decatur, AL (US); Lee R. Blakely JR., Mooresville, NC (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Avocent Corporation, Huntsville, AL (US)

(21) Appl. No.: 11/056,399

(22) Filed: Feb. 14, 2005

Related U.S. Application Data
(60) Provisional application No. 60/544,337, filed on Feb. 17, 2004.

(51) Int. Cl. H04K 1/00

(52) U.S. Cl. 705/50

(57) ABSTRACT

A framework for supporting the display of information includes at least one server; and one or more network virtual computers (NVCs) connected to the at least one server, each NVC also connected to a respective information display device. Each NVC is constructed and adapted to obtain video commands from the at least one server connected thereto, to decode the video commands; and to render information corresponding to the decoded commands on the information display device connected thereto. The commands may be HTML commands and the NVC decodes and renders the HTML commands. The server may include a screen-scraping mechanism to preprocess content, prior to sending it to a connected NVC, by converting the content to a generic file format such as MPEG or AVI.

### RELATIONSHIP TO OTHER APPLICATIONS

This application claims priority from U.S. Provisional Patent Application No. 60/544,337, filed Feb. 17, 2004, titled “Network Virtual Computing,” the contents of which are hereby incorporated herein by reference.

### FIELD OF THE INVENTION

This invention relates to computing systems, and, more particularly, to network computing systems.

### BACKGROUND AND SUMMARY OF THE INVENTION

A network virtual computer (NVC) according to embodiments of the present invention is a device, preferably a hardware device, that acts, in part, as a web browser. Information is sent from a server to an NVC in the same manner that a web server sends information to a regular computer on a network. This information is then rendered (typically displayed) locally, at the location of the NVC. The terminology used here, specifically the term “virtual computer”, is intended to define a minimal device that includes only those components needed to display the data. The information may include video and/or audio information.

An NVC device according to embodiments of the present invention provides local video and/or audio output based, e.g., on Internet standard communication protocols. In a fashion similar to that of viewing an Internet site, an NVC receives data from a remote server in a data format such as, e.g., HTML or the like, decodes this information and renders the decoded information in an appropriate manner on a video display and/or speakers.

The term “virtual” is used herein to denote the minimalist nature of the Network Virtual Computer. One skilled in the art will realize that not every NVC is optimally minimal, and that some NVCs will have more functionality that they require for a particular application.

### BRIEF DESCRIPTION OF THE FIGURES

For a more complete understanding of the present invention and the advantages thereof, reference should be made to the following Detailed Description taken in connection with the accompanying drawings, in which:

FIG. 1 depicts a logical view of a NVC according to embodiments of the present invention;

FIG. 2 depicts exemplary physical implementations of NVCs according to embodiments of the present invention;

FIGS. 3-6 depict operational aspects of NVCs according to embodiments of the present invention;

FIGS. 7-9 show aspects of operation of a system using NVCs according to embodiments of the present invention;

FIG. 10 shows an example configuration of system at an airport terminal; and

FIG. 11 is a flowchart of a screen scraping algorithm according to embodiments of the present invention.

### DETAILED DESCRIPTION OF THE PRESENTLY PREFERRED EXEMPLARY EMBODIMENTS OF THE INVENTION

Conceptual Overview of a Network Virtual Computer

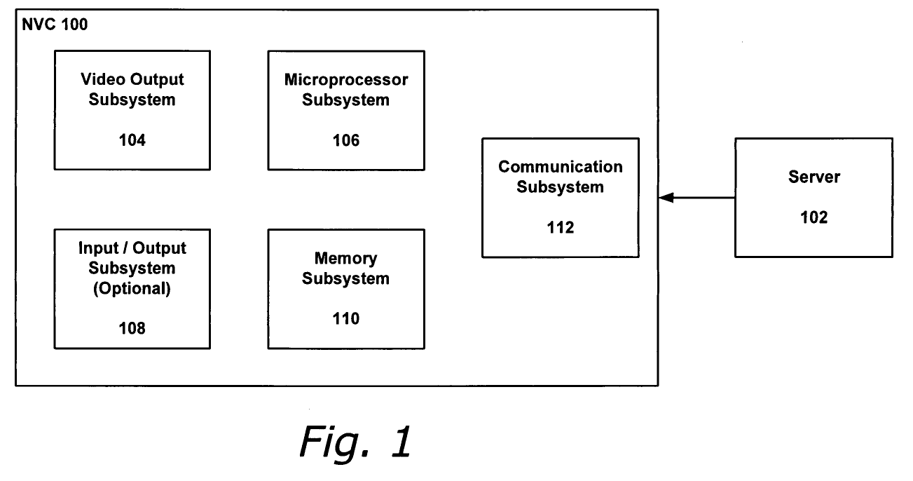

A basic NVC system 100 according to embodiments of the present invention consists of five modular subsystems as shown in FIG. 1 and is preferably controlled by a connected server 102. (In some embodiments, the NVC may also include some local controls.) The NVC 100 includes a video (and/or audio) output subsystem 104, a microprocessor subsystem 106, an optional input/output (I/O) subsystem 108, a memory subsystem 110, and a communications subsystem 112.

A video (/audio) output subsystem 104 according to embodiments of the present invention preferably supports video devices such as, e.g., computer VGA monitors and composite video (TV) devices and the like. In some embodiments of the present invention, the video output subsystem 104 may include an interface for touch screen applications and possibly DVI (a device independent format) support. A video output subsystem 104 according to embodiments of the present invention may support TV displays with support, e.g., for interactive TV and TV-based web-surfing. NTSC and PAL and other regional standards may be supported.

An input and output subsystem 108 may include the ability to support generic I/O to a server. Embodiments of an NVC may have a variety of modules allowing support of different I/O—serial, USB, PS/2, parallel and the like. This information may be communicated to the controlling server as generic input data, so that potentially it does not matter what type of devices are employed at a user station, as the data presented to and acted upon by the server would be the same. An I/O subsystem 108 is optional, and may be omitted from NVCs intended for “display only” applications. A serial port, when provided, returns a serial data stream as embedded HTML system input.

A microprocessor subsystem 106 supports the basic operations of the NVC 100. In some embodiments of the present invention, a more advanced microprocessor subsystem 106 may include support for more advanced display graphics and I/O. The processor(s) user are preferably capable of high performance in a convection cooled environment (allowing for quiet deployment). For basic implementations, the processor is capable of maintaining PowerPoint-like animation at the intended resolution of a video monitor connected to the DVC. In some embodiments of the present invention, the processor has the option to do a network boot of the operating system (“OS”) when networked to a controlling server. The operating system selected is capable of supporting multiple video chips based upon future availability. A Linux-based operating system is presently preferred. The supported browser is capable of being displayed without chrome or any windowed appearances in a full screen mode and the browser may suppress all error messages and pop ups. Errors received are not display on the screen, and, in the event of errors, the system continues on to another display item. Operating system and BIOS display are overridden during boot process. The device must recover from unexpected resets and power loss.

Preferably the processor supports VGA (RGB) out, and some DVI, with VGA resolution: 1280×1024. The processor may have video chip support. In some embodiments of the present invention, the processor supports processor based video output capable of the required resolution.

A memory subsystem 110 according to embodiments of the present invention needs to support the NVC 100 and so will depend on the application for which the NVC is to be used. A basic implementation includes minimal memory for HTML or specific high level language support with minimal caching. Advanced implementations allow more advanced display graphics. In some embodiments of the present invention, the memory subsystem 110 allows for local caching, e.g., of MPEG-encoded video sequences, animated GIFs, and the like. This caching allows for video sequences (e.g., animated ads, video clips, etc.) to be played back from local memory, giving the NVC the ability to run real-time pseudo-dynamic video even in low bandwidth applications. The memory subsystem 110 may be implemented in Random Access Memory (RAM) and is configurable for customer specific applications. The system may decompress OS image into RAM and from RAM to avoid memory contamination. Operating variables and option settings are saved as non-volatile and may be mirrored in memory in a separate memory block from the OS

A communication subsystem 112 according to embodiments of the present invention supports communication with an external device or processor such as, e.g., server 102, and includes support for various communications systems and protocols, e.g., Ethernet and/or wireless. Preferably connectivity may be wire Ethernet (preferably including at least 10/100 base T); WiFi Ethernet (possibly via optional add on card); modem; digital cellular; and/or serial multi-drop.

An NVC 100 according to embodiments of the present invention may be used without any add-on software for simple web-based auto-browsing intended to display data. The basic functionality of serial I/O for touch screen and generic applications may be supported with simple HTML (or other high level language) system control. However, for some systems, users may require a more complete and product-specific interface in order to have better control over the data that are transmitted from and received by the server 102. This software adds the ability to control multiple types and feeds of input and output from individual NVC devices, and supports hosting a variety of different applications at the same time. Additionally, some embodiments of the present invention provide the ability to interface easily to existing in-house communication and security structures.

Because of the contexts in which NVCs are to be deployed (many are public display systems), boot-time information that might be displayed on a monitor may be controlled and may be user defined/configurable. In this manner, a user has the ability to load graphic file with, e.g., corporate logo to be displayed at boot in place of the usual, typical boot-time information. Booting of the device may be via the network or stand alone. For security reasons, IP Address and other system information typically displayed at boot time on a splash screen may be configurable by the user.

The system preferably includes an embedded basic web interface that allows a user to access and control basic functionality and simple scheduling independent of any network software.

Content scheduling functionality is provided with NVCs according to some embodiments of the present invention. Using content scheduling, a user has the ability to define a URL, schedule a dwell time for display, download, store and edit. As to dwell time, contiguous play and continuous play, the system has an option to play file to completion, and continue on to next file in schedule. In some embodiments of the present invention, a user can set a resolution of display dwell time per URL (e.g., 1 second). Some embodiments allow a loop option to start from top of schedule upon completion of last file in schedule. Schedules preferably point to URLs or files on a local computer. In some embodiments, the number of URLs is limited, e.g., a maximum of say sixty four URLs can be entered. Once the schedule is defined for an NVC unit, a user has the option to store the schedule on the device and an option to store it (by name/IP address) on the computer being used to access the web interface. Device storage of a schedule is capable of 7 day/24 hour/day scheduling. Scheduling executes a schedule automatically in the event of server loss, or the reboot/power cycle of a device.

Preferably the scheduling functionality is available via a web interface. In order to achieve portability, a user accessing the device via the web interface is able to download the current schedule, make changes, rename, etc, and then download back to system. Schedules are generically designed such that they are able to be loaded to different devices. For example. a schedule may be defined for one device servicing an area, and may be downloaded to that device. Then, another device may be accessed, and the same schedule may be downloaded to that device. Schedules may be imported from a spreadsheet (e.g., Excel) in a pre-determined format, such as comma delimited. Schedules may be overwritten or disabled by the network.

If a fault is detected in a server, an NVC device is capable of fault detection and switching to mirrored server.

An NVC according to embodiments of the present invention preferably has at least the following basic functionality:
a browser interface to server supporting HTTPS protocol with login required. LDAP or Kerberos may be used for authentication to third party. In some cases, the system may support locally stored credentials.
a player management interface which includes some or all of the following functions: select player from list, search for new players; manage play set configuration parameters; network configuration; owner information (for accounting); copy from other players; monitor player health, define alarm thresholds, and define actions to take on alerts (e.g., SNMP traps, Emails, pages/cell phone); snapshot what is currently playing, reset/reboot player; select which schedule a player will follow; force download of media libraries that are appropriate, group players (groups of players can be managed like one player); override current schedule/play-list for special information, then return to standard schedule.
a media management interface which includes some or all of the following functions: tree based approach (folders); drag & drop media files; convert media files to a format that the player will understand (e.g., PowerPoint to MPEG2); assign accounting information to media files (e.g., cost/minute to play a particular media file; and vendor/customer information).
a play-list management interface which includes some or all of the following functions: create play-lists by drag & dropping media files; set play times for still images; calculate times for moving pictures; preview play-lists. Play-lists may be hierarchical, i.e., one play-list can be part of another.
a schedule interface which includes some or all of the following functions/features: drag & drop play lists to create schedules; set start & stop times; assign schedule to multiple players/groups of players.
a billing/accounting interface which includes some or all of the following functions/features: tracks play time of “billed for” media; verifies with players that media actually played; exports accounting data to various types of files (e.g., Spreadsheet; CSV file, and the like).
a monitor & alerts interface which includes some or all of the following functions: view current alarms; view past alarms; clear alarms; monitor current status; and set alarms thresholds, email addresses, etc.
   Content Management

A NVC according to some embodiments of the present invention supports content management functionality. E.g., in scenarios where content to be displayed is based upon a data stream provided to a customer, (e.g., flight information data from airlines and OAG feeds and the like) that will have to be stored, parsed, formatted and then displayed) the software will be able to receive the feeds and write to a database file. This file may then be accessed by software used to format the data and provide the data to the display device(s) in a constant update mode via, e.g., HTML data transmission.

A system preferably supports user notification of content submission. A system may, e.g., generate email denoting new content located in a database.

The content management functionality according to embodiments of the present invention supports various user levels, including Executive Level; Provider Level; Director Level; Manager Level; Supervisor Level; Technician Level; and User Level.

An Executive Level user is capable of all functions without , exception, can assign all functional users, user rights, passwords and user levels; can define Provider Level access rights, database directory structure for content, content source setup, password assignment, etc; can define Provider Level User access to install content to Approved database without need of using Pre-Approval database; can define mirror server(s); can define time slots within Play list Schedules for individual Manager Levels to insert content A Provider Level user can post and retrieve content to content database pre approval directories and sub-directories; can access Content Tagging function to define and describe individual content files; can retrieve usage play list reports and billing data.

A Director Level user is capable of all functions of lower hierarchical users; can review and approve content and post data to approved content database directories and subdirectories; Can establish and name database access directories. These directories can be used to define, separate, and catalog groups of content; can define and grant access to these groups to lower hierarchical users; can access content tagging function to define and describe individual content files; can access Content Grouping function to define and describe individual content groups; can define scheduled play lists from approved content access directories and to approved devices or device groups within all jurisdictions; can assign functional users, user rights, passwords and user levels for lower hierarchical users; can group devices; can group content; can initiate Interrupt Content display within all jurisdictions; can force ALL OFF/CONTINUE condition within all jurisdictions; can grant Technician Level non-hierarchical access to any devices or device groups; can grant Technician Level non-hierarchical access to any content or content groups.

A Manager Level user is capable of all functions of lower hierarchical users (users defined can only access content and group within access rights of Manager. Options disallowed to Manager automatically disallowed to User Levels under Manager). A manager level user can assign functional users, user rights, passwords and user levels for lower hierarchical users; can define scheduled play lists from approved content access directories and to approved devices or device groups within defined jurisdictions; can initiate Interrupt Content display within defined jurisdictions; can force ALL OFF/CONTINUE condition within defined jurisdictions; can add/modify text filter definition (ability to generate word lists that will be filtered if attempted to use in text overlays, e.g., by disgruntled employee, hacked systems, etc); can enable/disable web browser interface to devices within jurisdiction; can configure content data streaming displays and content storage facilities associated.

A Supervisor Level user is capable of all User Level access; can monitor activity of devices, displays and billing logs; can monitor and control serial port of display screen.

A Technician Level user can perform device software upgrade/option settings; can perform Networks control software upgrades and option settings; can access grouped or individual devices within a Test Content group; can access and change Boot Sequence options; can enable/disable web browser interface to individual devices (not groups) within jurisdiction; and can monitor and control serial port of display screen.

A User Level user can access grouped or individual devices within jurisdiction; can provide changes to textual overlay tagged content; can monitor serial port of display screen.

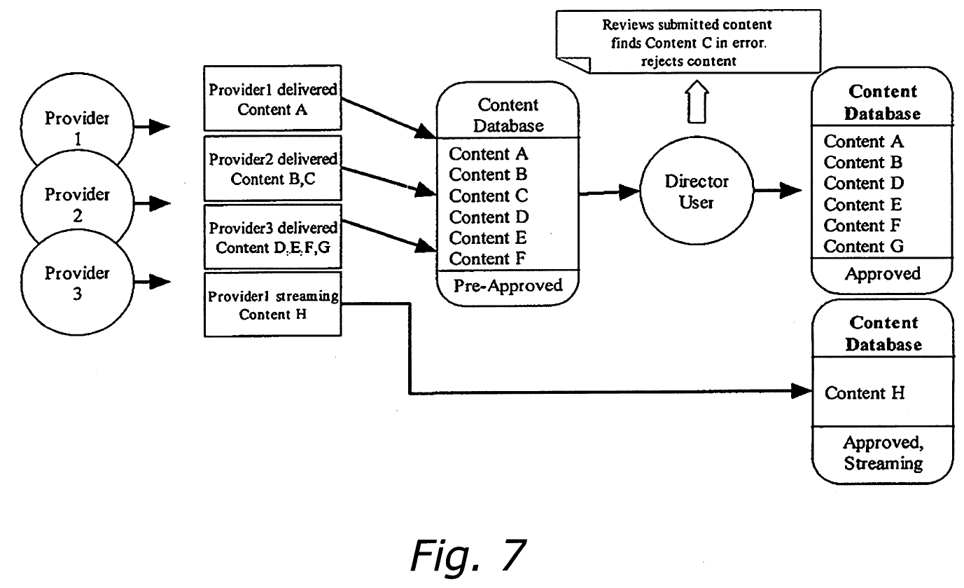

FIG. 7 shows an aspect of operation of a system according to embodiments of the present invention. As shown in FIG. 7, three providers deliver content to content databases. A director user reviews content submitted and rejects some of the content. The other content is put in the content database as approved.

Some implementations of NVCs according to embodiments of the present invention provide support for content tagging. Content tagging is not required for functionality, it is provided as a management tool to help users better define the nature of the content. E.g., in some cases, content tagging provides the ability to define the content in terms of definition, description. type. date, author, customer and priority of content. For example, a user may want to examine the database for all content provided by a specific provider The tag allows all of the content to be sorted, viewed. grouped, etc.

Content may be given a name and may be defined/classified, e.g., as Primary Content; Commercial Interlude Content; Graphic Overlay Content; Interrupt Content; Emergency Information Override; Public Information Broadcast Information; and Textual Overlay Content. In applications such as office displays, the User Level can be given permissions to make changes to the background and/or messages to be displayed on the local display or display group. Therefore, content can be tagged as Background and made available for display at the discretion of the user. Additionally, text messages can be defined at the user level to display current information such as meeting times, greetings, etc.

Content that is not tagged can be directly referenced by filename only.

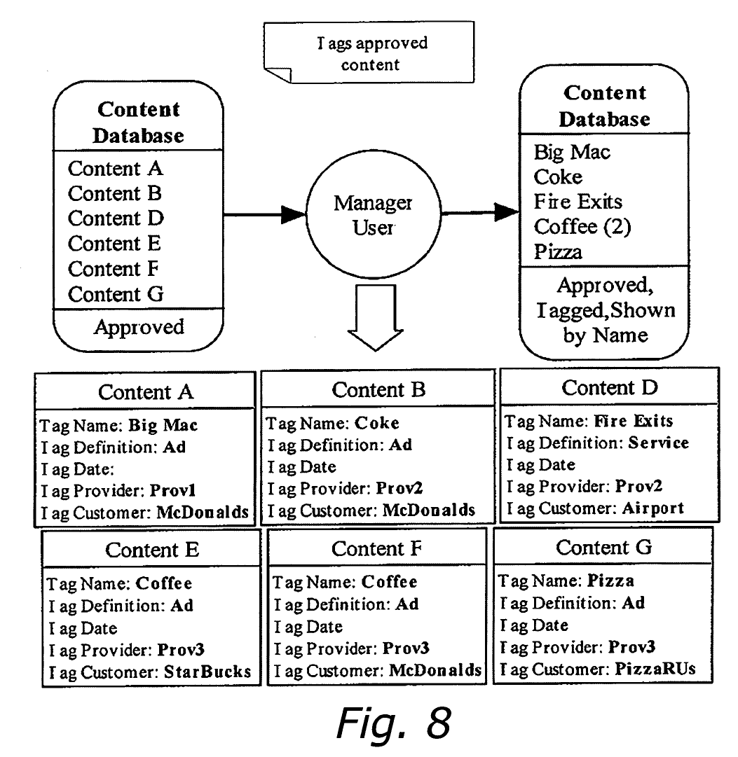

FIG. 8 shows an example of tagging of content.

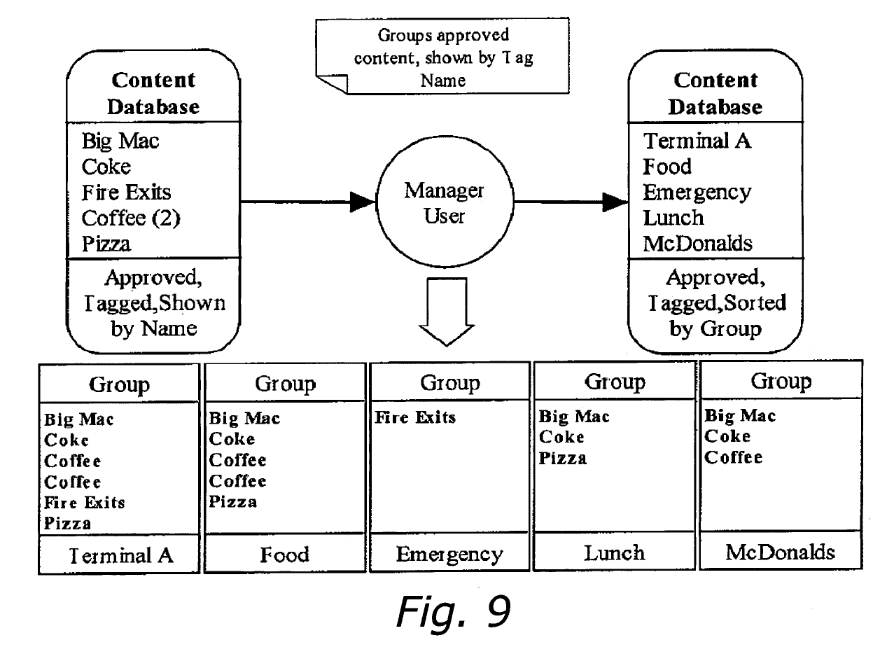

Content Grouping gives the user the ability to deal with a large number of discrete files as a single entity. One file can exist in any number of groups. Content that is not Tagged can still be grouped. References to the file is only by filename. Various features allow for management of content groups, including: creating a group; adding a tagged file to a group; adding an untagged file to a group; deleting a file in a group; updating a file in a group; and deleting a group. FIG. 9 shows an example of content grouping.

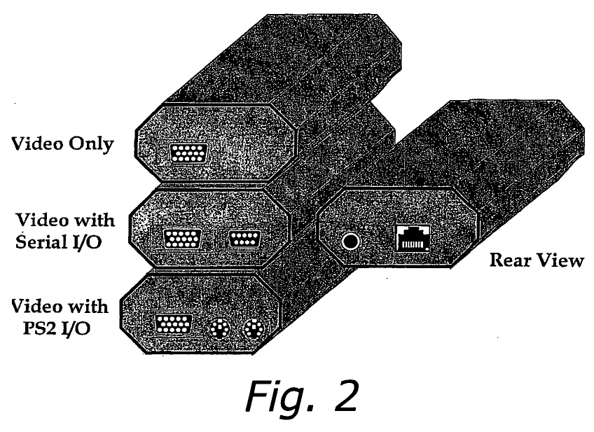

FIG. 2 depicts physical implementations of four exemplary NVCs according to embodiments of the present invention. A typical NVC would preferably be of a small size, made, e.g., of molded plastic and include the appropriate input and output ports. As shown in FIG. 2, an NVC may be, e.g., video only, video with serial I/O, and video with PS2 I/O. One skilled in the art will realize that any combination of I/O connections may be supported. An implementation of a DVC according to embodiments of the present invention includes the following connectors /external controls/LEDs: power; serial (DB9); VGA out; recessed reset button (used to restore factory defaults); power indicator; and Ethernet activity indicator.

A NVC according to embodiments of the present invention supports one or more of the following types of content: HTML; JPEG; GIF; Macromedia Flash; PowerPoint; MPEG; textual overlay; graphical overlay; AVI; and MP3.

Audio output is not necessary in all implementations of NVCs. Additionally, some NVCs may support audio output without video output.

An NVC according to embodiments of the present invention allows a server to control multiple devices with different video simultaneously. The interface on a NVC output is a high-level output. There is no access to the system upon which the actual application is running. Generic I/O allows for a variety of devices to be employed at the user input station. It is irrelevant to an application as to whether this data is obtained via PS/2, serial, USB or any other type of actual interface.

An NVC according to embodiments of the present invention does not require the high bandwidth which means that the communication of the NVC can be routed via a variety of communication methods, including lower speed wireless devices. Peripheral support from the NVC is preferably generic. An NVC can have multiple devices providing input to the server, each independent of the other and an NVC may have multiple different video outputs from a single server.

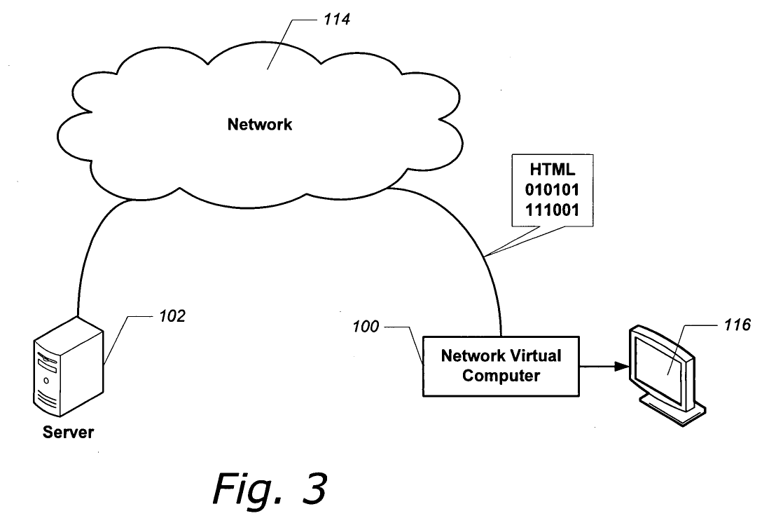

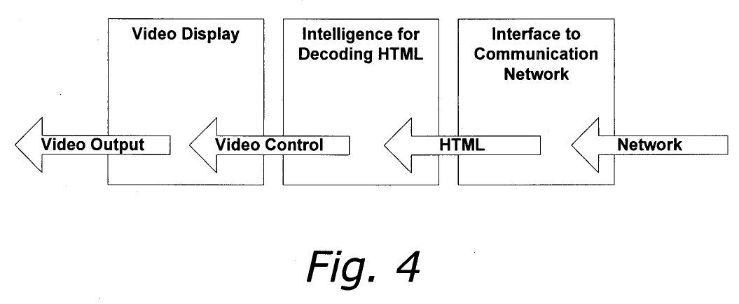

Thus, as described herein, an NVC according to embodiments of the present invention is a generally a hardware device that acts, in some aspects, as a web browser. Information is sent from a server to the NVC product in the same way that a web server sends information to a computer. This information is displayed locally. For example, with reference to FIG. 3 which depicts operation of NVCs according to embodiments of the present invention, an NVC 100 connects to a server 102 via a network 114. The network 114 may be a LAN, WAN, the Internet, an intranet or internet or the like. Output from the NVC 100 is rendered (displayed) on the video monitor 116. The NVC is referred to as a virtual computer because the device is made up only of the components needed to display the data, as opposed to an entire computer usually required at the viewing end. This paradigm allows a very small form factor product at a very inexpensive cost of sales. Various embodiments of the present invention add the ability for input, opening markets beyond simple information distribution, such as ATM and point of sales. This minimal concept is shown in the NVC block diagram in FIG. 4.

According to some embodiments of the present invention, an NVC may provide local video output based upon Internet standard communication. Similar to the experience of viewing an Internet site, the NVC receives data from a remote server in a data format such as HTML, decodes this information, and creates a rendering (e.g., video screen) based upon those data. The NVC preferably uses only the components of a typical computer that are necessary to performing this function, which drastically reduces the size, cost, and complexity of this device.

The NVC may, in some embodiments, include an add-on software component allowing development of customer-specific displays and interfaces to customer specific control and database servers. This software may be used in a per system basis, where a system may include one or more NVC products connected to a server that is running this software. The software provides not only content for the display, but also acts as an interface between the NVC and the customer's existing network.

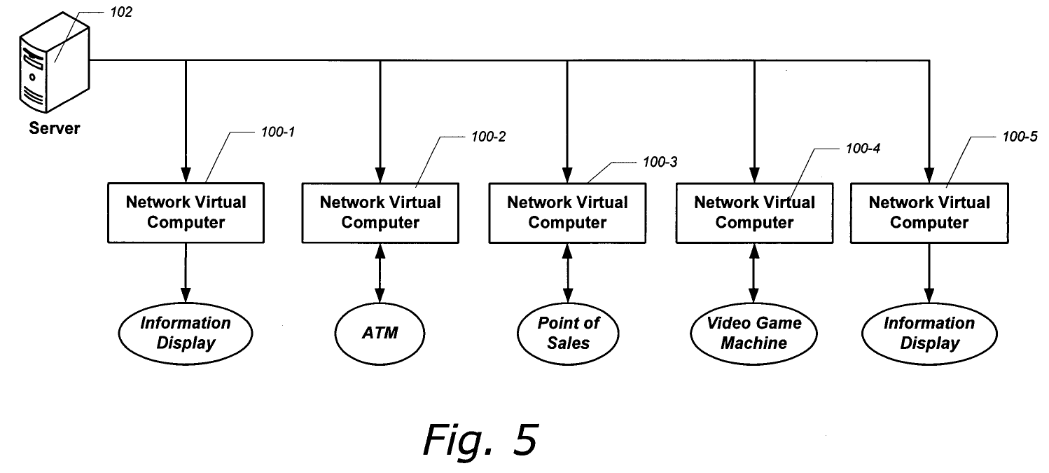

In general, the NVC is given the commands to produce video from a server that communicates to the device. (E.g., see the server 102 in FIG. 5). This server 102 performs this function in the same way that any typical web server provides content to normal Internet browsing. Because the NVC is connected to a server as an Internet-like appliance, multiple NVC devices can be controlled by this single server, as shown in the example in FIG. 5 (e.g., NVCs 101-1 to 101-5 in FIG. 5). Each device can be individually addressed to output unique data, or the devices can be broadcasted so that each one displays the same data. The overall system can be managed as individually as needed to perform the given tasks.

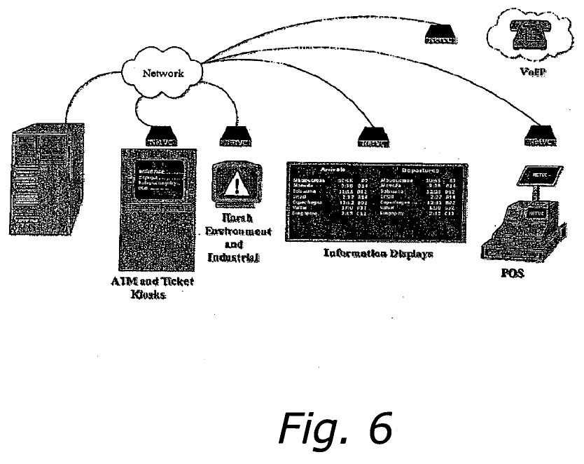

FIGS. 5 and 6 are simple diagrams of applications of NVCs according to embodiments of the present invention, implemented in a system. Since the HTML driven system can be individually addressed to a specific NVC device, each device can display totally different applications, only limited by the ability of the server and the bandwidth of the media.

A typical computer used to display internet sites also generally has the ability/capacity to store large files to hard disk, to perform complex computational tasks, support and operating system and a myriad of other items. By focusing on the electronics needed to receive and render information on a display device, the complexity of an NVC is a fraction of that of a regular PC.

Applications

One skilled in the art will realize that NVCs according to embodiments of the present invention have numerous applications. Some particular applications are listed here, by way of example only. NVCs according to embodiments of the present invention may be used, e.g., flight information displays, public information displays; corporate office information displays systems; call centers and the like.

A system according to embodiments of the present invention has the ability to accept template or content input from any HTML file.

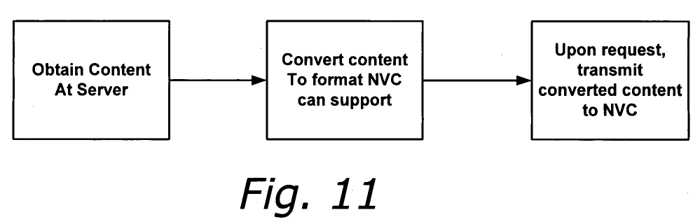

Some embodiments provide the ability to pre-process content at the server to convert content that is application/plug-in specific a generic format. In that manner, the content can be viewed using the device without requiring the specific application/plug in to be installed at the device. This process is referred to as screen scraping. For example, PowerPoint support would require that Power Point be installed in the server. The pre-processor module would then play the content and read the frame buffer of the PC and convert the RGB output to a generic file format such as MPEG2, AVI, or some other file format that can be understood by the device. Upon the event requirement to display or download the content to the device, the server would supply the post-conversion data to the device in the understandable format. FIG. 11 is a flowchart of the screen scraping process according to embodiments of the present invention. Content is obtained at a server, converted to a format that the NVC can support, and, upon request, sent to the NVC.

### EXAMPLES

An example application of NVCs is described in the context of a major retail store. A major retail store installs an NVC at each register. Each register station includes a touch screen monitor, a bar scanner, a receipt printer, a credit card reader and a cash drawer (all serial connections). Each monitor displays a keypad for manual entries, and also displays the product information and total purchase price. As each product is scanned, the NVC server receives the data, and queries the database server as to the product's price. The server updates the current screen with this information. Note that no actual computing takes place at the register station itself. When all products are scanned, the customer chooses to pay via a credit or debit card and requires a cash return. The card reader information is sent to the server, and the server passes the information to the computer system that controls payment systems. Upon authorization, the NVC server updates the screen to indicate acceptance and change due. Control data from the payment computer tell the NVC that the payment is authorized and change is due, whereupon the NVC server updates the screen and opens the cash drawer. A receipt is printed based upon the information data from the server.

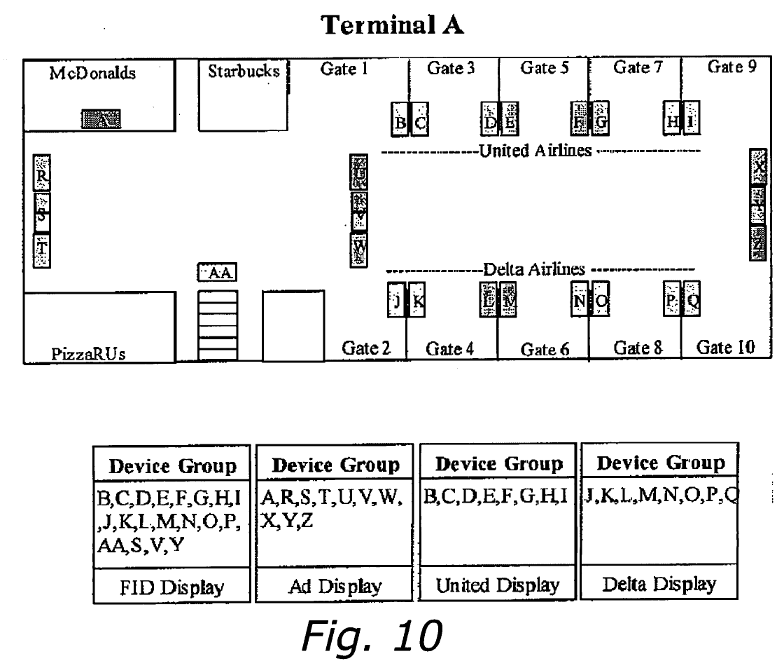

FIG. 10 shows an example configuration of system/framework at an airport terminal. As shown in the drawing, the terminal has 27 displays. These displays are used for flight information displays and/or advertising. The displays are located such that each gate has displays, the main concourse has displays, and one restaurant has a display. The gates are set up such that there are two airlines requiring specific flight information to be displayed at their respective gates. The concourse is setup such that some of the displays will display only advertisement information, while others may be able to display both flight and advertisement information. The restaurant is setup such that its display will display only information relevant to its corporate advertising campaigns. By grouping the NVC devices (named A-AAA) into four groups, we can define device groups to which we can tailor schedules.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A framework for supporting the display of information comprising:
at least one server; and
one or more network virtual computers (NVCs) connected to the at least one server, each NVC also connected to a respective information display device, wherein each NVC is constructed and adapted to obtain video commands from the at least one server connected thereto, to decode the video commands; and to render information corresponding to the decoded commands on the information display device connected thereto.

2. A framework as in claim 1 wherein the commands are HTML commands and wherein the NVC is constructed and adapted to decode and render the HTML commands.

3. A framework as in claim 1 wherein the server includes a screen-scraping mechanism constructed and adapted to preprocess content, prior to sending it to a connected NVC, by converting the content to a generic file format.

4. A framework as in claim 3 wherein the generic file format is selected from the group consisting of: MPEG and AVI.

5. A framework as in claim 2 wherein the screen-scraping mechanism plays the content on a processor of the server, reads a frame buffer and converts an RGB output into a generic file format.

6. In a system comprising at least one network virtual computer (NVC) connected to a server, a method comprising:
obtaining content at the server;
converting the content to a format that is supported by the at least on NVC; and
providing the converted content from the server to the NVC.

7. A method as in claim 6, wherein the converting comprises converting the content to one of MPEG2 or AVI file formats.

8. A method as in claim 6, wherein the converting is performed by:
playing the content on the server;
reading the frame buffer of the server; and
converting the RGB output to a generic file format.
